(19) United States
(12) Patent Application Publication
(10) Pub. No.: US 2022/0068103 A1
(43) Pub. Date: Mar. 3, 2022

(54) Separation Alarm Assembly

(71) Applicant: Phillip Williams, Dearborn, MI (US)

(72) Inventor: Phillip Williams, Dearborn, MI (US)

(21) Appl. No.: 17/009,023

(22) Filed: Sep. 1, 2020

(51) Int. Cl. G08B 21/02; H04N 7/18; B60R 11/00; B60R 11/04; B60N 2/56; B60H 1/00

(52) U.S. Cl. CPC G08B 21/0205; G08B 21/0236; H04N 7/185; G08B 21/0288; B60R 11/00; B60R 2011/0064; B60N 2/5635; B60N 2/5657; B60H 1/00521; B60R 2011/0017; B60R 2011/0059; B60R 11/04

(57) ABSTRACT

A separation alarm assembly for preventing leaving of a child in a vehicle includes a transmitter, which is couplable to an object and which utilizes radio frequency transmission. Alert programming code positioned on an electronic device of a user enables the electronic device to receive transmissions from the transmitter, to determine a distance between the transmitter and the electronic device, and to alert the user should the distance exceed a preset value.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to alarm assemblies and more particularly pertains to a new alarm assembly for preventing leaving of a child in a vehicle.

### (2) Description of Related Art Including Information Disclosed Under 37 CFR 1.97 and 1.98

The prior art relates to alarm assemblies, which may comprise proximity sensors, transmitters, and receivers.

### BRIEF SUMMARY OF THE INVENTION

An embodiment of the disclosure meets the needs presented above by generally comprising a transmitter, which is configured to be couplable to an object and for radio frequency transmission. Alert programming code positioned on an electronic device of a user enables the electronic device to receive transmissions from the transmitter, to determine a distance between the transmitter and the electronic device, and to alert the user should the distance exceed a preset value.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a separation alarm assembly according to an embodiment of the disclosure.

FIG. 2 is a back view of an embodiment of the disclosure.

FIG. 3 is a front view of an embodiment of the disclosure.

FIG. 4 is a side view of an embodiment of the disclosure.

FIG. 5 is a bottom view of an embodiment of the disclosure.

FIG. 6 is an in-use view of an embodiment of the disclosure.

FIG. 7 is an in-use view of an embodiment of the disclosure.

### DETAILED DESCRIPTION OF THE INVENTION

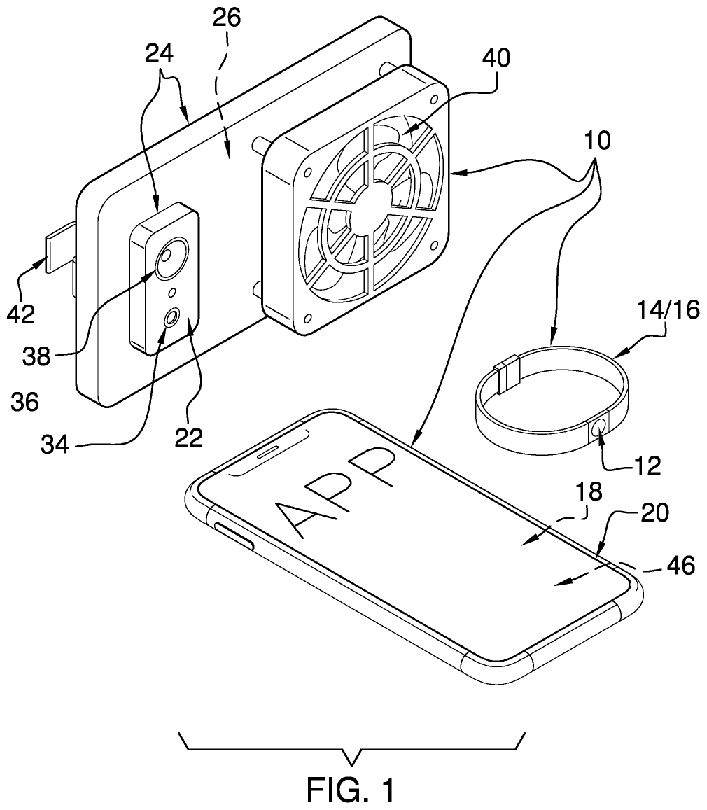

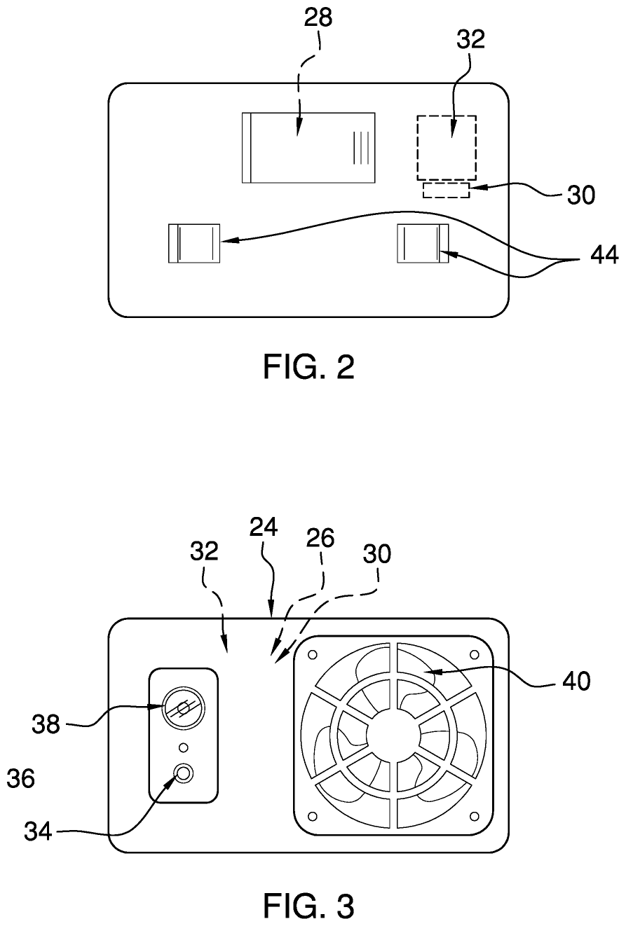

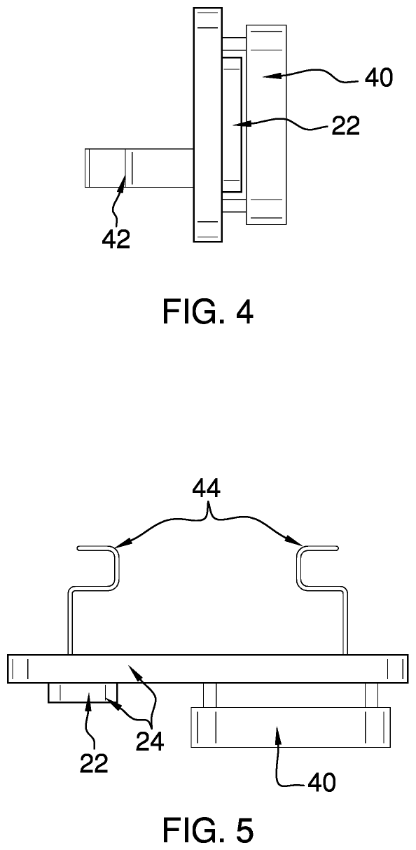

With reference now to the drawings, and in particular to FIGS. 1 through 7 thereof, a new alarm assembly embodying the principles and concepts of an embodiment of the disclosure and generally designated by the reference numeral 10 will be described.

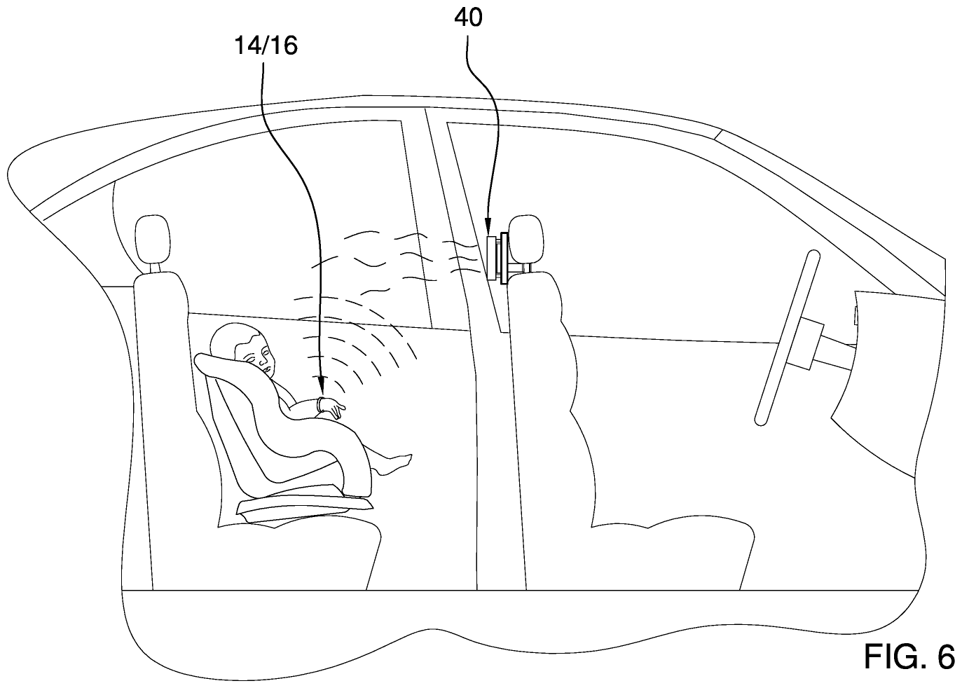

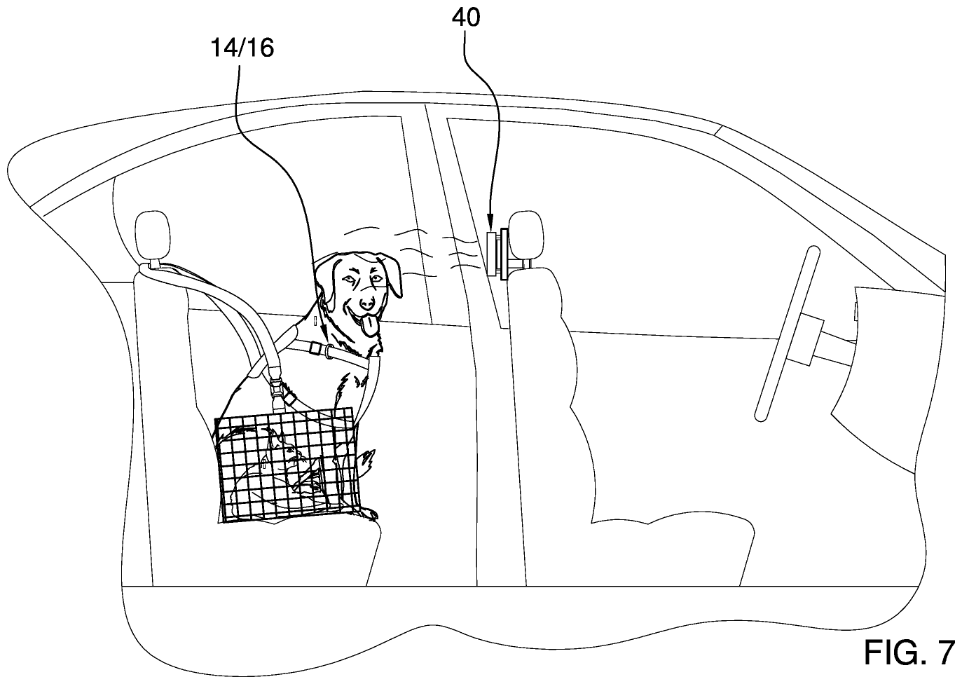

As best illustrated in FIGS. 1 through 7, the separation alarm assembly 10 generally comprises a transmitter 12, which is configured to be couplable to an object, such as, but not limited to, a child, a pet, and a valuable or perishable article. The transmitter 12 is configured for radio frequency transmission. The transmitter 12 may be integral to a wristband 14 or a bracelet 16, as shown in FIGS. 1, 6, and 7. The wristband 14 or the bracelet 16 is configured to position around a wrist of the child, as shown in FIG. 6. The wristband 14 or the bracelet 16 also could be attached to a collar or harness of the pet, as shown in FIG. 7. Additionally, the present invention anticipates the transmitter 12 being incorporated into other articles that can be used to affix the transmitter 12 to various objects, such as a tag attachable to a piece of luggage or a cooler, such as a cooler used to transport organs.

Alert programming code 18 positioned on an electronic device 20 of a user enables the electronic device 20 to receive transmissions from the transmitter 12, to determine a distance between the transmitter 12 and the electronic device 20, and to alert the user should the distance exceed a preset value. The alert programming code 18 may alert the user when the distance between the transmitter 12 and the electronic device 20 exceeds 4.57 meters, or other preset distance.

The assembly 10 also may comprise a monitoring unit 22, which is configured to be mountable to a rear face of a front seat of a vehicle, to capture an image of an object positioned on a rear seat of the vehicle and to transmit the image to the electronic device 20 of the user.

The monitoring unit 22 comprises a housing 24, which defines an interior space 26. A battery 28, a microprocessor 30, and a transceiver 32 are engaged to the housing 24 and are positioned in the interior space 26. The microprocessor 30 is operationally engaged to the battery 28 and the transceiver 32.

A camera 34, a microphone 36, and a speaker 38 are engaged to the housing 24 and are operationally engaged to the microprocessor 30. The microprocessor 30 is positioned to selectively actuate the camera 34 and the microphone 36 to capture the image of and sounds produced by the object positioned on the rear seat of the vehicle, respectively.

The microprocessor 30 is positioned to selectively actuate the transceiver 32 to transmit the image captured by the camera 34 and the sounds received by the microphone 36 to the electronic device 20 of the user. The microprocessor 30 also is positioned to selectively actuate the speaker 38 to broadcast a transmission received from the electronic device 20 via the transceiver 32.

A fan 40 is engaged to the housing 24 and is operationally engaged to the microprocessor 30. The microprocessor 30 is positioned to selectively actuate the fan 40. The fan 40 is configured to blow air on the object, such as the child or the pet, positioned on the rear seat of the vehicle.

A fastener 42 is engaged to the housing 24 and is configured to selectively engage the front seat of the vehicle. The fastener 42 may comprise a pair of clips 44, as shown in FIG. 5, or other fastening means, such as, but not limited to, hook and loop fasteners, clamps, and the like. Each clip 44 is configured to selectively engage a respective extension rod of a headrest of the front seat.

The present invention also anticipates safety programming code 46 positioned on one or both of the microprocessor 30 and the electronic device 20. The safety programming code 46 would enable one or both of the microprocessor 30 and the electronic device 20 to interface with an electronic control unit of the vehicle to actuate an alarm and air conditioning unit of the vehicle, and to assure that doors of the vehicle are unlocked.

In use, the wristband 14 or the bracelet 16 is positioned around the wrist of the child positioned on the back seat of the vehicle. Should the user depart the vehicle and travel further than the preset distance, the alert programming code 18 would alert the user that the child still is in the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A separation alarm assembly comprising:
a transmitter configured to be couplable to an object, the transmitter being configured for radio frequency transmission; and
alert programming code positioned on an electronic device of a user enabling the electronic device for receiving transmissions from the transmitter, for determining a distance between the transmitter and the electronic device, and for alerting the user should the distance exceed a preset value.

2. The separation alarm assembly of claim 1, further including the transmitter being integral to a wristband or a bracelet, wherein the wristband or the bracelet is configured for positioning around a wrist of a child.

3. The separation alarm assembly of claim 1, wherein the alert programming code alerts the user when the distance between the transmitter and the electronic device exceeds 4.57 meters.

4. The separation alarm assembly of claim 1, further including a monitoring unit configured to be mountable to a rear face of a front seat of a vehicle and being configured for capturing an image of an object positioned on a rear seat of the vehicle and for transmitting the image to the electronic device of the user.

5. The separation alarm assembly of claim 4, further including the monitoring unit comprising:
a housing defining an interior space;
a battery engaged to the housing and positioned in the interior space;
a microprocessor engaged to the housing and positioned in the interior space, the microprocessor being operationally engaged to the battery;
a camera engaged to the housing and operationally engaged to the microprocessor, such that the microprocessor is positioned for selectively actuating the camera for capturing the image of the object positioned on the rear seat of the vehicle;
a microphone engaged to the housing and operationally engaged to the microprocessor, such that the microprocessor is positioned for selectively actuating the microphone for capturing sounds produced by the object positioned on the rear seat of the vehicle;
a transceiver engaged to the housing and positioned in the interior space, the transceiver being operationally engaged to the microprocessor, such that the microprocessor is positioned for selectively actuating the transceiver for transmitting the image captured by the camera and the sounds received by the microphone to the electronic device of the user; and
a speaker engaged to the housing, the speaker being operationally engaged to the microprocessor, such that the microprocessor is positioned for selectively actuating the speaker for broadcasting a transmission received from the electronic device via the transceiver.

6. The separation alarm assembly of claim 5, further including a fan engaged to the housing and operationally engaged to the microprocessor, such that the microprocessor is positioned for selectively actuating the fan, wherein the fan is configured for blowing air on the object positioned on the rear seat of the vehicle.

7. The separation alarm assembly of claim 5, further including a fastener engaged to the housing and being configured for selectively engaging the front seat of the vehicle.

8. The separation alarm assembly of claim 7, wherein the fastener comprises a pair of clips, each clip being configured for selectively engaging a respective extension rod of a headrest of the front seat.

9. A separation alarm assembly comprising:
a transmitter configured to be couplable to an object, the transmitter being configured for radio frequency transmission, the transmitter being integral to a wristband or a bracelet, wherein the wristband or the bracelet is configured for positioning around a wrist of a child;
alert programming code positioned on an electronic device of a user enabling the electronic device for receiving transmissions from the transmitter, for determining a distance between the transmitter and the electronic device, and for alerting the user should the distance exceed a preset value, the alert programming code alerting the user when the distance between the transmitter and the electronic device exceeds 4.57 meters;
a monitoring unit configured to be mountable to a rear face of a front seat of a vehicle and being configured for capturing an image of an object positioned on a rear seat of the vehicle and for transmitting the image to the electronic device of the user, the monitoring unit comprising:
a housing defining an interior space,
a battery engaged to the housing and positioned in the interior space, a microprocessor engaged to the housing and positioned in the interior space, the microprocessor being operationally engaged to the battery,
a camera engaged to the housing and operationally engaged to the microprocessor, such that the microprocessor is positioned for selectively actuating the camera for capturing the image of the object positioned on the rear seat of the vehicle,
a microphone engaged to the housing and operationally engaged to the microprocessor, such that the microprocessor is positioned for selectively actuating the microphone for capturing sounds produced by the object positioned on the rear seat of the vehicle,
a transceiver engaged to the housing and positioned in the interior space, the transceiver being operationally engaged to the microprocessor, such that the microprocessor is positioned for selectively actuating the transceiver for transmitting the image captured by the camera and the sounds received by the microphone to the electronic device of the user, and
a speaker engaged to the housing, the speaker being operationally engaged to the microprocessor, such that the microprocessor is positioned for selectively actuating the speaker for broadcasting a transmission received from the electronic device via the transceiver;
a fan engaged to the housing and operationally engaged to the microprocessor, such that the microprocessor is positioned for selectively actuating the fan, wherein the fan is configured for blowing air on the object positioned on the rear seat of the vehicle; and
a fastener engaged to the housing and being configured for selectively engaging the front seat of the vehicle, the fastener comprising a pair of clips, each clip being configured for selectively engaging a respective extension rod of a headrest of the front seat.
